(19) United States
(12) Patent Application Publication
(10) Pub. No.: US 2015/0096785 A1
(43) Pub. Date: Apr. 9, 2015

(54) MULTICORE CABLE

(71) Applicant: SUMITOMO ELECTRIC INDUSTRIES, LTD., Osaka (JP)

(72) Inventors: Tatsunori HAYASHISHITA, Hachinohe-shi (JP); Yuuki ISOYA, Hachinohe-shi (JP)

(21) Appl. No.: 14/503,465

(22) Filed: Oct. 1, 2014

(30) Foreign Application Priority Data
Oct. 3, 2013 (JP) 2013-208054

(51) Int. Cl. H01B 11/02; H01B 11/18; H01B 3/30

(52) U.S. Cl. CPC H01B 11/02; H01B 3/30; H01B 11/18
USPC 174/113 R

(57) ABSTRACT

One embodiment provides a multicore cable in which plural coaxial cable pairs are collected. Each coaxial cable pair is formed by twisting together or arranging in parallel two coaxial cables. Each coaxial cable includes a center conductor and an insulator covering the center conductor. The center conductor is a strand of nineteen or more wires or a single wire.

### CROSS-REFERENCE TO RELATED APPLICATION(S)

This application claims priority from Japanese Patent Application No. 2013-208054 filed on Oct. 3, 2013, the entire contents of which are incorporated herein by reference.

### FIELD

An aspect of the present invention relates to a multicore cable that is used for transmission of signals such as high-speed digital signals.

### BACKGROUND

With the advancement of the information communication technologies, the frequency bands of communication cables have expanded to gigahertz bands. For example, the differential signal transmission using two insulated wires is mainly used in the interface cables for connection between computers and other devices. This differential signal transmission in which positive-phase and negative-phase differential signals (having a phase difference of 180°) are input to two insulated wires simultaneously, transmitted through them, and combined together differentially on the reception side can increase the output level and has a noise eliminating function.

When a differential signal transmission is performed, a time difference (delay time difference) occurs between arrival times at the reception side if the two insulated wires have a difference in signal transmission speed. This delay time difference, which is called a skew, causes adverse effects such as waveform distortion in a reception signal and noise to the outside. The signal delay time depends on the electrical length which is determined by the physical length of a signal conductor and the wavelength shortening rate. The wavelength shortening rate depends on the square root of the relative permittivity εᵣε of the insulating layer that is interposed between the signal conductor and a shield conductor, and the relative permittivity εᵣε relates to the capacitance and the ratio of the outer diameter of insulating layer and the conductor diameter. The skew becomes large in the case where a difference occurs in relative permittivity in connection with the insulator of each of the two insulated wires.

Among techniques for decreasing the skew as mentioned above is one disclosed in JP-2012-146409-A which relates to a multicore signal cable that incorporates plural coaxial cables in each of which a stranded-wire center conductor is covered with an insulator. In this multicore signal cable, the skew variation in the cable longitudinal direction is reduced by decreasing gaps between the center conductor and the insulator by making the adhesion ((pull-out strength)/(conductor cross section)) between the center conductor and the insulator higher than or equal to a prescribed value.

In a pair of insulated wires in which two insulated wires are twisted together or arranged parallel with each other, the skew is small if they have the same structure. However, if gaps occur between the center conductor and the insulator upon covering of outer circumferential surface of the center conductor with the insulator in manufacture of an insulated wire, the permittivity may vary to thereby increase the skew in the longitudinal direction of the insulated wires.

In JP-2012-146409-A, the skew variation is reduced by optimizing the adhesion between the stranded-wire center conductor and the insulator. However, it is desired to further reduce the skew in the cable longitudinal direction by making gaps between the center conductor and the insulator even smaller.

### SUMMARY

One object of the present invention is therefore to provide a multicore cable in which the skew in the cable longitudinal direction is reduced by stabilizing the permittivity of each coaxial cable.

An aspect of the invention provides a multicore cable in which plural coaxial cable pairs are collected, each coaxial cable pair being formed by twisting together or arranging in parallel two coaxial cables, each coaxial cable including a center conductor and an insulator covering the center conductor, wherein the center conductor is a strand of nineteen or more wires or a single wire.

According to the above-mentioned aspect of the invention, it is possible to provide a multicore cable in which the skew in the cable longitudinal direction is reduced by making the permittivity of each coaxial cable stable.

### BRIEF DESCRIPTION OF DRAWINGS

FIG. 1 is a sectional view showing the configuration of an example multicore cable according to the present invention.

FIG. 2 is a sectional view showing the configuration of an example coaxial cable pair to be used for forming the multicore cable shown in FIG. 1.

FIG. 3 is a sectional view showing the configuration of another example coaxial cable pair to be used for forming the multicore cable shown in FIG. 1.

### DETAILED DESCRIPTION

An embodiment of the present invention provides following Aspects 1-4.
1. 1 A multicore cable in which plural coaxial cable pairs are collected, each coaxial cable pair being formed by twisting together or arranging in parallel two coaxial cables, each coaxial cable including a center conductor and an insulator covering the center conductor, wherein the center conductor is a strand of nineteen or more wires or a single wire.

With this configuration, a multicore cable can be obtained in which the permittivity of each coaxial cable can be made stable and the skew in the cable longitudinal direction can thereby be reduced.
2. The above-mentioned multicore cable, wherein each coaxial cable further includes an outer sheath which is made of PET tape or a fluororesin, wherein the center conductor has an outer diameter in a range of 0.078 mm to 0.255 mm (a range corresponding to AWG #30 to #40), and wherein the insulator is made of fluorinated PFA or FEP.

With these measures, a small-diameter multicore cable that is suitable for high-speed digital signal transmission between information processing apparatus can be obtained. In addition, a fluororesin is effective at decreasing the cable diameter because of its high thinning workability. Furthermore, a fluororesin enables superior flex resistance because of its small dynamic friction coefficient.
3. The above-mentioned multicore cable, wherein each coaxial cable further includes an outer conductor which is formed around an outer circumferential surface of the insulator, and wherein the outer conductor is formed by spirally winding wires that satisfy a relationship that a ratio of a diameter of the wire to an outer diameter of the insulator is smaller than or equal to 0.09, so as to have a winding angle of 5° to 10°.

With these measures, a multicore cable can be obtained which incorporates coaxial cables each of which is thin, superior in flexibility and flex resistance (mechanical characteristics), economy and shielding performance.
4. The above-mentioned multicore cable, wherein the center conductor is the strand of nineteen wires.

With these measures, the gaps that are formed both outside and inside the center conductor can be made smaller. As a result, the variation of the permittivity in the longitudinal direction of each coaxial cable can be decreased, and the skew can be reduced.

A multicore cable according to the embodiment will be hereinafter described with reference to the drawings. The invention is not limited to the following embodiment, but every modification thereof will fall within the scope of the invention.

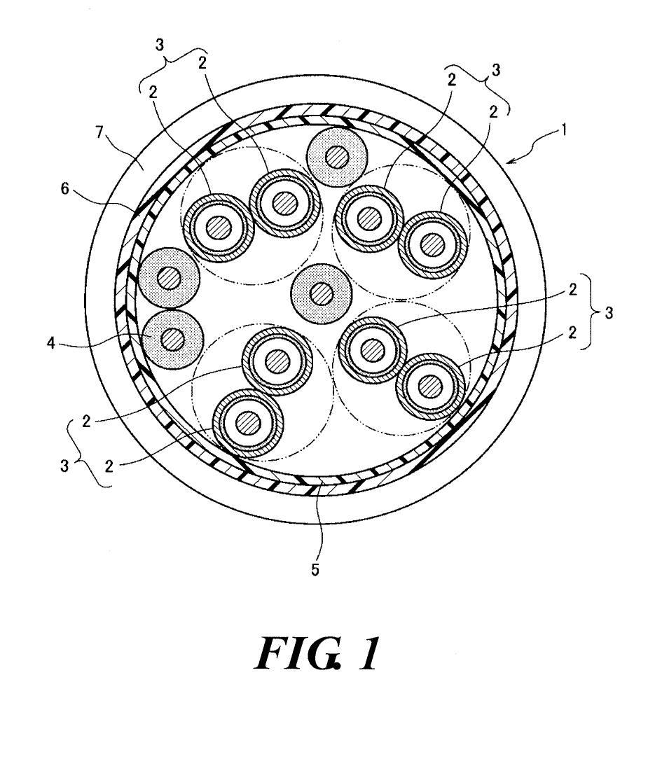

FIG. 1 is a sectional view showing the configuration of a multicore cable 1 according to the embodiment. As shown in FIG. 1, the multicore cable 1 is composed of pairs of coaxial cables 2 (each pair is denoted by reference numeral 3), other cables 4, a wrapping 5, a shield conductor 6, and a cable sheath 7.

The multicore cable 1 has plural coaxial cable pairs 3 in each of which two coaxial cables 2 are twisted together or arranged parallel with each other. In each coaxial cable 2, a center conductor is covered with an insulator. Although this embodiment exemplifies the case of using four pairs of coaxial cables 3, the number of coaxial cable pairs 3 is not limited to any particular number. As necessary, the multicore cable 1 may incorporate other cables 4 in addition to the plural coaxial cable pairs 3. The other cables 4 may be used as a low-speed signal transmission cable, a ground line, a power line, etc.

The wrapping 5 is provided to maintain the shape of the integral collection of the plural coaxial cable pairs 3 and the other cables 4. The wrapping 5 is formed by winding a resin tape or the like around the collection of the plural coaxial cable pairs 3 laterally (spirally). The whole shield conductor 6 is formed by winding plural shield metal wires laterally around the outer circumferential surface of the wrapping 5, covering the outer circumferential surface of the wrapping 5 with a braid of plural shield metal wires, or winding a metal tape laterally around the wrapping 5. The whole shield conductor 6 and protected by the cable sheath 7 by covering the outer circumferential surface of the shield conductor 6. The cable sheath 7 can be formed by extruded coating using such a resin as polyethylene (PE), polyvinyl chloride (PVC), an ethylene-vinyl acetate (EVA) copolymer, or polyurethane.

With a coaxial cable pair 3 (i.e., a pair of two coaxial cables 2), the signal output level can be doubled on the reception side by inputting signals having a phase difference of 180° to the two coaxial cables 2 simultaneously, transmitting the signals through them, and combining the signals differentially on the reception side. Furthermore, even if introduced in a transmission path from the transmission side to the reception side, noise equally acts on the two coaxial cables 2 and hence can be cancelled and eliminated when the differential signals are combined together on the reception side.

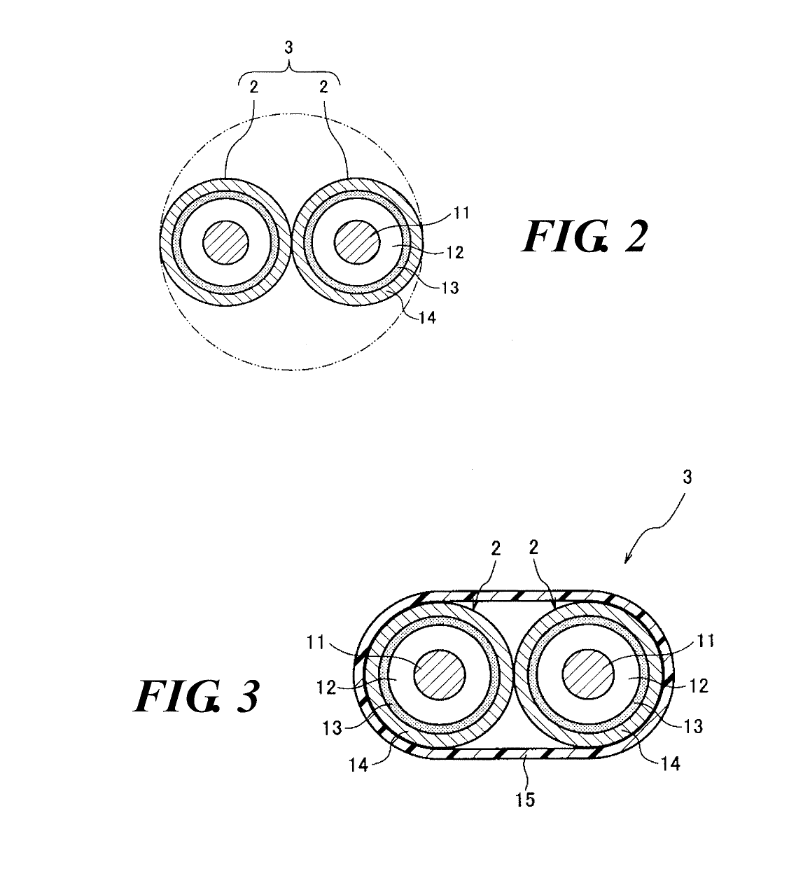

FIG. 2 is a sectional view showing the configuration of an example coaxial cable pair 3 to be used for forming the multicore cable 1. This example coaxial cable pair 3 has a configuration that two coaxial cables 2 are twisted together.

In each coaxial cable 2, a center conductor 11 is covered with an insulator 12, an outer conductor 13 is formed around the outer circumferential surface of the insulator 12, and the outer conductor 13 is covered with an outer sheath 14. The center conductor 11 is stranded wires or a single wire (each of). Each wire is formed of, for example, a tin-plated annealed copper wire, a tin-plated copper alloy wire, a silver-plated annealed copper wire, a silver-plated copper alloy wire. In either case, the outer diameter of the center conductor 11 is set at a value in a range corresponding to AWG (American wire gauge) #30 to #40. For example, the outer diameter of the center conductor 11 may be in the range of 0.078 mm to 0.255 mm. This coaxial cable pair 3 contributes to form a small-diameter multicore cable that is suitable for high-speed digital signal transmission between information processing apparatus.

The insulator 12 may be made of a fluororesin such as a tetrafluoroethylene-hexafluoropropylene copolymer (FEP) or a tetrafluoroethylene-perfluoroalkylvinyl ether copolymer (PFA). It is preferable to use a highly heat-resistant fluororesin obtained by fluorinating the above fluororesin. A fluororesin may be obtained by fluorinating end groups (—CF₃). Alternatively, a fully fluorinated fluororesin may be used. Exhibiting high thinning workability, fluororesins are suitable for diameter reduction of cables. Furthermore, having small dynamic friction coefficients, fluororesins provide superior flex resistance.

The outer conductor 13 is a conductor obtained by laterally winding tin-plated annealed copper wires, for example. The wire should satisfy a relationship (wire diameter (mm))/(outer diameter of insulator (mm))≦0.09. For example, where the outer diameter of the center conductor 11 corresponds to AWG #40 and the outer diameter of the insulator 12 is 0.24 mm, the wire diameter of the outer conductor wire is set at 0.021 mm or smaller. The lateral winding angle is set at 5° to 10°. The winding angle is defined as an inclination angle from the longitudinal center axis of the coaxial cable 2. The flex resistance is insufficient if the winding angle is larger than 10°, and a resulting outer conductor 13 (shield layer) may be opened during manufacture if the winding angle is smaller than 5°. By forming the outer conductor 13 by laterally winding conductive wires that satisfy the relationship (wire diameter (mm))/(outer diameter of insulator (mm))≦0.09, a coaxial cable 2 can be obtained which is thin, superior in flexibility and flex resistance (mechanical characteristics), economy and shielding performance.

The outer conductor 13 may be a braid of wires. To enhance the shielding function, a metal foil may be provided in addition to the outer conductor 13.

The outer sheath 14 is formed by winding a resin tape such as a polyester (PET) tape. Alternatively, the outer sheath 14 may be formed by extruded coating using a resin such as a fluororesin.

FIG. 3 is a sectional view showing the configuration of another example coaxial cable pair 3 to be used for forming the multicore cable 1. As shown in FIG. 3, this coaxial cable pair 3 is configured in such a manner that two coaxial cables 2 are arranged parallel with each other instead of being twisted together and an intended shape is maintained by a wrapping 15.

Like the one described above with reference to FIG. 2, each coaxial cable 2 is formed by covering a center conductor 11 with an insulator 12, forming an outer conductor 13 around the outer circumferential surface of the insulator 12, and covering the outer conductor 13 with an outer sheath 14. The structure of a coaxial cable pair 3 is maintained by forming the wrapping 15 around the two parallel coaxial cables 2. The wrapping 15 may be formed by winding a resin tape such as a polyester tape.

In the embodiment, to further reduce the skew in each coaxial cable pair 3 of the multicore cable 1, a single wire or a strand of nineteen or more wires is used as the center conductor 11 of each coaxial cable 2.

As described above, if gaps are formed between the center conductor 11 and the insulator 12, the permittivity varies, as a result of which the delay time varies in the longitudinal direction of the coaxial cable 2 to increase the skew. Where the center conductor 11 of each coaxial cable 2 is a strand of wires, the surface of the strand of wires are formed with undulations and gaps are formed between the center conductor 11 and the insulator 12. Gaps are also formed inside the strand of wires.

However, in the embodiment, since the center conductor 11 of each coaxial cable 2 is a strand of nineteen or more wires, the gaps are smaller than in an ordinary case that the center conductor 11 is a strand of seven wires. That is, since each wire constituting the center conductor 11 is thinner than each wire constituting the ordinary center conductor which is a strand of seven wires, the undulations formed in the surface of the strand of wires become smaller, and the gaps between the center conductor 11 and the insulator 12 are made smaller. The gaps formed inside the strand of wires are also made smaller. That is, the gaps that are formed both outside and inside the center conductor 11 are made smaller. As a result, the variation of the permittivity in the longitudinal direction of each coaxial cable 2 can be decreased and hence the skew can be reduced.

In the embodiment, alternatively, the center conductor 11 of each coaxial cable 2 may be a single wire rather than a strand of wires. In this case, in principle, no gaps are formed inside the center conductor 11. And center conductor 11 has even smaller undulations than in the case where it is a strand of wires, which contributes to reduction of gaps outside the center conductor 11. As a result, the variation of the permittivity of each coaxial cable 2 can be made smaller and hence the skew can be reduced.

### EXAMPLES

Coaxial cable pairs 3, that is, pairs of coaxial cables 2, are produced as Examples and Comparative Example and subjected to skew measurements. In each coaxial cable 2, the center conductor 11 is covered with an insulator (FEP) 12, an outer conductor 13 is formed around the outer circumferential surface of the insulator 12, and the outer conductor 13 is covered with an outer sheath 14. The outer conductor 13 is formed of spirally-wound tin-plated annealed copper wires. The outer diameter of the center conductor 11 is set at a value corresponding to AWG #34. Delay times of sample coaxial cables 2 are measured with a digital signal analyzer, and a skew (difference between delay times) is calculated on the basis of a measured maximum delay time and minimum delay time.

In Example 1, the center conductor 11 is a strand of nineteen wires having a stranding pitch of 5 mm. In Example 2, a single wire is employed as the center conductor 11. In Comparative Example, the center conductor 11 is a strand of seven wires having a stranding pitch of 5 mm.

Results of the skew measurements are as follows:

Example 1 (strand of nineteen wires): 5.0 ps/m

Example 2 (single wire): 6.8 ps/m

Comparative Example (strand of seven wires): 7.0 ps/m

Since the center conductor 11 is a strand of nineteen wires, the undulations formed in the surface of the center conductor 11 become smaller than in Comparative Example (strand of seven wires) and hence the gaps between the center conductor 11 and the insulator 12 can be made smaller. The gaps formed inside the strand of nineteen thinner wires can also be made smaller. As a result, the variation of the permittivity in the longitudinal direction of each coaxial cable 2 can be decreased and the skew can be reduced successfully.

Where the center conductor 11 is a single wire, the gaps that are formed both outside and inside the center conductor 11 can be made even smaller. However, since the flatness of the surface of the center conductor 11 is increased (i.e., it is made smoother), when the insulator 12 is formed around the circumferential surface of the center conductor 11 by extruded coating, the anchor effect is lowered because minute undulations decreases in the surface, possibly resulting in reduction of bonding strength. In such a case, the insulator 12 may peel off the single-wire center conductor 11 in portions of their interface to form small gaps. However, even in Example 2 which employs a single-wire center conductor 11, the skew can be smaller than in Comparative Example (strand of seven wires). Example 2 is thus advantageous over Comparative Example.

1. A multicore cable in which plural coaxial cable pairs are collected, each coaxial cable pair being formed by twisting together or arranging in parallel two coaxial cables, each coaxial cable including a center conductor and an insulator covering the center conductor,
wherein the center conductor is a strand of nineteen or more wires or a single wire.

2. The multicore cable of claim 1,
wherein each coaxial cable further includes an outer sheath which is made of PET tape or a fluororesin,
wherein the center conductor has an outer diameter in a range of 0.078 mm to 0.255 mm, and
wherein the insulator is made of fluorinated PFA or FEP.

3. The multicore cable of claim 1,
wherein each coaxial cable further includes an outer conductor which is formed around an outer circumferential surface of the insulator, and
wherein the outer conductor is formed by spirally winding wires that satisfy a relationship that a ratio of a diameter of the wire to an outer diameter of the insulator is smaller than or equal to 0.09, so as to have a winding angle of 5° to 10°.

4. The multicore cable of claim 1,
wherein the center conductor is the strand of nineteen wires.
